(19) United States
(12) Patent Application Publication
(10) Pub. No.: US 2014/0071955 A1
(43) Pub. Date: Mar. 13, 2014

(54) Dynamic Sounding Control In Wifi

(71) Applicants: Shu Du, Milpitas, CA (US); Zhanfeng Jia, Belmont, CA (US); Ning Zhang, Saratoga, CA (US); Guido Robert Frederiks, Aptos, CA (US); Vincent Knowles Jones, IV, Redwood City, CA (US); Sameer Vermani, San Diego, CA (US); Chin-Hung Chen, San Jose, CA (US); Rahul Tandra, San Diego, CA (US); Qinghai Gao, San Jose, CA (US); Balaji Srinivasan Babu, Chennai (IN)

(72) Inventors: Shu Du, Milpitas, CA (US); Zhanfeng Jia, Belmont, CA (US); Ning Zhang, Saratoga, CA (US); Guido Robert Frederiks, Aptos, CA (US); Vincent Knowles Jones, IV, Redwood City, CA (US); Sameer Vermani, San Diego, CA (US); Chin-Hung Chen, San Jose, CA (US); Rahul Tandra, San Diego, CA (US); Qinghai Gao, San Jose, CA (US); Balaji Srinivasan Babu, Chennai (IN)

(73) Assignee: Qualcomm Atheros, Inc., San Jose, CA (US)

(21) Appl. No.: 13/615,446

(22) Filed: Sep. 13, 2012

(51) Int. Cl. H04B 7/04

(52) U.S. Cl. CPC H04B 7/0452
USPC 370/336

(57) ABSTRACT

A method of performing dynamic sounding in a wireless communication device includes determining whether to perform sounding based on an age of current channel state information (CSI). An achievable throughput can be recorded as a reference throughput after performing the sounding. A current achievable throughput can be compared with the reference throughput. A CSI timestamp can be reset when the current throughput is above the reference throughput by a first predetermined amount, thereby prolonging a lifespan of the current CSI. The CSI timestamp can be reduced when the current throughput is below the reference throughput by a second predetermined amount, thereby reducing the lifespan of the current CSI.

### BACKGROUND OF THE DISCLOSURE

IEEE 802.11 refers to a set of standards for implementing wireless local area network (WLAN) communication in the 2.4, 3.6, and 5 GHz frequency bands. WLAN communication allows a device to exchange data wirelessly with one or more other devices. WiFi™ is a brand name for WLAN products using any of the IEEE 802.11 standards. IEEE 802.11ac is a new standard being developed to support Very High Throughput (VHT) operations in 5 GHz frequency band. To obtain this VHT operation, an 802.11ac device uses a wide RF (radio frequency) bandwidth up to 160 MHz, up to 8 MIMO (multiple-input multiple-output, which refers to multiple antennas used at both the transmitter and receiver) spatial streams, MU-MIMO (which refers to a multi-user MIMO that allows a terminal to transmit (or receive) signals to/from multiple users in the same frequency band simultaneously), and a high-density modulation up to 256 QAM (quadrature amplitude modulation).

Beamforming is a technique using directional signal transmission or reception with multiple antennas to achieve spatial selectivity. For example, a transmitter can control the phase and amplitude of the signals at each antenna to create a pattern of constructive and destructive interference in the wavefront. To correctly form a beam for MIMO communication, the transmitter needs to know the characteristics of the channel. To obtain these channel characteristics, the transmitter can send a known signal to a device, which allows that device to generate information regarding the channel. The device can then send this channel state information (CSI) back to the transmitter, which in turn can apply the correct phases and amplitudes to form the optimized beam directed at the device. This process is called channel sounding or channel estimation (referenced as the sounding process herein).

In 802.11ac communication, an access point (AP) node can use the sounding process to collect CSI from one or more potential destination stations. Thereafter, the AP node can use the collected CSI as the current channel estimation to send downlink data to multiple stations in a MU-MIMO frame. Note that the collected CSI can also be used to send downlink data to one station in an SU-MIMO frame, wherein SU-MIMO is a single-user MIMO (a beamforming technique using multiple antennas at one station).

FIG. 1A illustrates a small basic service set (BSS) 100 including an AP and two stations STA1 and STA2. In one embodiment, each device includes a transceiver 310 (transmitter and receiver) configured for operation in accordance with the 802.11ac standard. FIG. 1B illustrates an exemplary communication between the AP and the stations STA1 and STA2. This exemplary communication can be characterized as including two processes: a sounding process 110 and a data process 111. Sounding process 110 begins with the AP sending a null data packet announcement (NDPA) signal 101 to stations STA1 and STA2, wherein the NDPA signal 101 indicates that no data will be sent in the subsequent packet. Following the NDPA signal 101, the AP sends a null data packet (NDP) signal 102. This NDP signal 102 can serve as a known signal for obtaining channel characteristics from the stations STA1 and STA2. In accordance with the 802.11ac standard, after receipt of NDP signal 102, station STA1 can send its CSI in a beamforming (BF) report1 signal 103; the AP can send a BF poll signal 104 indicating that the station STA2 can send its channel characteristics; and the station STA2 can then sends its CSI in a BF report2 signal 105.

Using the CSI from its associated stations STA1 and STA2, the AP can begin the data process 111 by simultaneously sending MU-MIMO data 106 to station STA1 and MU-MIMO data 107 to station STA2. Note that although the term MU-MIMO is used to describe the data, the data may also be SU-MIMO in other embodiments. After receiving the data 106, the station STA1 can send a block acknowledgement (BA) signal 108; the AP can send a block acknowledgement request (BAR) signal 109 for the station STA2; and the station STA2 can send its BA signal 110 in response. Note that although FIG. 1 shows an AP associated with two stations, in other embodiments the AP can be associated with any number of stations, each of which can send a BF report signal during the sounding process 110 and a BA signal during the data process 111.

Because the sounding process has a large overhead in terms of medium air time, the AP is typically configured not to do sounding prior to every MU-MIMO data transmission. For example, FIG. 2 illustrates a first sounding process 201(1) followed by a plurality of data processes 202(1)-202(N), wherein N is an integer greater than 2. After the N data processes are complete, a second sounding process 202(2) is performed before another plurality of data processes are performed (not shown).

When the MU-MIMO data is sent out immediately after a sounding process, the CSI used for MU-MIMO data transmission is fresh. Therefore, the data packets will have a high chance of being successfully received. In contrast, if the MU-MIMO data is sent out after some time duration since the last sounding process, e.g. after N data packets in FIG. 2, the CSI used in generating the MU-MIMO data transmission can be stale. Therefore, in that case, the data packets may have a low chance of being successfully received.

A typical way to control when to do sounding is to setup a pre-determined expiration time for every CSI collected from the sounding process. If the AP node needs to perform MU-MIMO to some destination, but the latest CSI collected has passed its expiration time, then the AP will perform sounding for that destination. Although this method of sounding control is simple, it is difficult to determine the best expiration time of the CSI. Specifically, the signal to interference and noise ratio (SINR) of two MU-MIMO transmissions (or SU-BF transmissions) can be significantly different even when the CSI has the same age, depending upon the channel conditions or the MU-MIMO level (e.g. grouped with 2-user, 3-user, etc.).

For example, the CSI for a channel with induced Doppler can vary extremely fast. In this case, even 5 ms after sounding, the SINR of a MU-MIMO transmission can degrade significantly. In contrast, in a relatively stable channel, the SINR can generally degrade much slower. As noted above, the SINR after sounding can degrade differently based on MU-MIMO level (1 user, 2 users, etc.). In general, the higher the MU-MIMO level (i.e. the more users), the faster the SINR will degrade after sounding. Therefore, a need arises for a system and technique that provides a dynamically adjustable sounding interval based on current channel conditions.

### SUMMARY OF THE EMBODIMENTS

A method of performing dynamic sounding in a wireless communication device is described. This method includes receiving a data request, such as a multi-user multiple-input multiple-output (MU-MIMO) request or a beamforming request. When channel state information (CSI) has expired, as determined by comparing a current timestamp to a CSI timestamp (i.e. a time of a last CSI update), then a sounding can be performed and the CSI timestamp can be updated. After the sounding, a data transmission can be performed in accordance with the data request, and a reference achievable throughput Rref, which is associated with the sounding, can be computed. In contrast, when the CSI has not expired, the data transmission can be performed in accordance with the data request and a current achievable throughput Rcurr can be recorded. Using the current achievable throughput Rcurr and the reference achievable throughput Rref, a sounding interval can be extended or shortened.

Comparing the current timestamp to the CSI timestamp can include determining whether the CSI timestamp subtracted from the current timestamp is greater than a predetermined default CSI lifespan expiration time D. In one embodiment, the predetermined default CSI lifespan expiration time D can be derived from a transmit mode and a Doppler profile. Computing the reference achievable throughput Rref can include computing a product of a physical rate of the data transmission performed immediately after sounding and a value indicative of transmission quality. In one embodiment, the value indicative of transmission quality can be 1 minus a packet error rate (PER).

Using the current achievable throughput Rcurr and the reference achievable throughput Rref to determine whether the sounding interval is extended or shortened can further include, after recording the current achievable throughput Rcurr, determining whether the current achievable throughput Rcurr is greater than a product of the reference achievable throughput Rref and a predetermined factor α. When the current achievable throughput Rcurr is greater than the product of the reference achievable throughput Rref and the predetermined factor α, the CSI timestamp can be updated to equal the current timestamp, thereby extending the sounding interval. Further, when the current achievable throughput Rcurr is greater than the reference achievable throughput Rref, the current achievable throughput Rcurr can be designated as the new reference achievable throughput Rref. In one embodiment, the predetermined factor α is set to a value between 0 and 1.

Using the current achievable throughput Rcurr and the reference achievable throughput Rref to determine whether the sounding interval is extended or shortened can also include, after recording the current achievable throughput Rcurr, determining whether the current achievable throughput Rcurr is less than a product of the reference achievable throughput Rref and a predetermined factor β When the current achievable throughput Rcurr is less than the product of the reference achievable throughput Rref and the predetermined factor β, the CSI timestamp can be reduced by a predetermined delay d, thereby shortening the sounding interval. In one embodiment, the predetermined factor β can be set to a value between 0 and 1. For example, 0<β<α≦1.

An electronic device is also described. This electronic device, along with other components, includes a processor block and a communication block. The communication block includes a dynamic sounding block, which is configured to perform the above-described steps.

A non-transitory, computer-readable medium storing computer-executable instructions is also described. These instructions can advantageously perform dynamic sounding for a transmitter of a wireless device. The instructions when executed by a processor cause the processor to execute a process comprising the above-described steps.

Another method of performing dynamic sounding in a wireless communication device is described. This method includes determining whether to perform sounding based on an age of current channel state information (CSI). An achievable throughput as a reference throughput can be updated after performing the sounding. A current achievable throughput can be compared with the reference throughput. A CSI timestamp can be reset when the current throughput is above the reference throughput by a first predetermined amount, thereby prolonging a lifespan of the current CSI. In contrast, the CSI timestamp can be reduced when the current throughput is below the reference throughput by a second predetermined amount, thereby reducing the lifespan of the current CSI.

### BRIEF DESCRIPTION OF THE DRAWINGS

FIG. 1A illustrates a small basic service set (BSS) including an AP and two stations STA1 and STA2.

FIG. 1B illustrates an exemplary communication between an AP and two stations, the communication including a sounding process and a data process.

FIG. 2 illustrates an exemplary prior art communication between an AP and two stations in which the sounding process is performed periodically, i.e. after a predetermined number of data processes.

FIG. 3 illustrates an exemplary dynamic sounding technique based on current channel conditions.

FIG. 4 illustrates an exemplary electronic device configured to implement the dynamic sounding technique of FIG. 3.

### DETAILED DESCRIPTION OF THE DRAWINGS

In accordance with one preferred embodiment, dynamically adjustable sounding interval can be used instead of a fixed sounding interval. In this embodiment, the sounding interval can be dynamically adjusted based on the current channel conditions. Thus, when the current channel condition is substantially unchanged since a last sounding, a next sounding can be postponed. In contrast, when the current channel condition has degraded to a predetermined level, the sounding interval can be shortened.

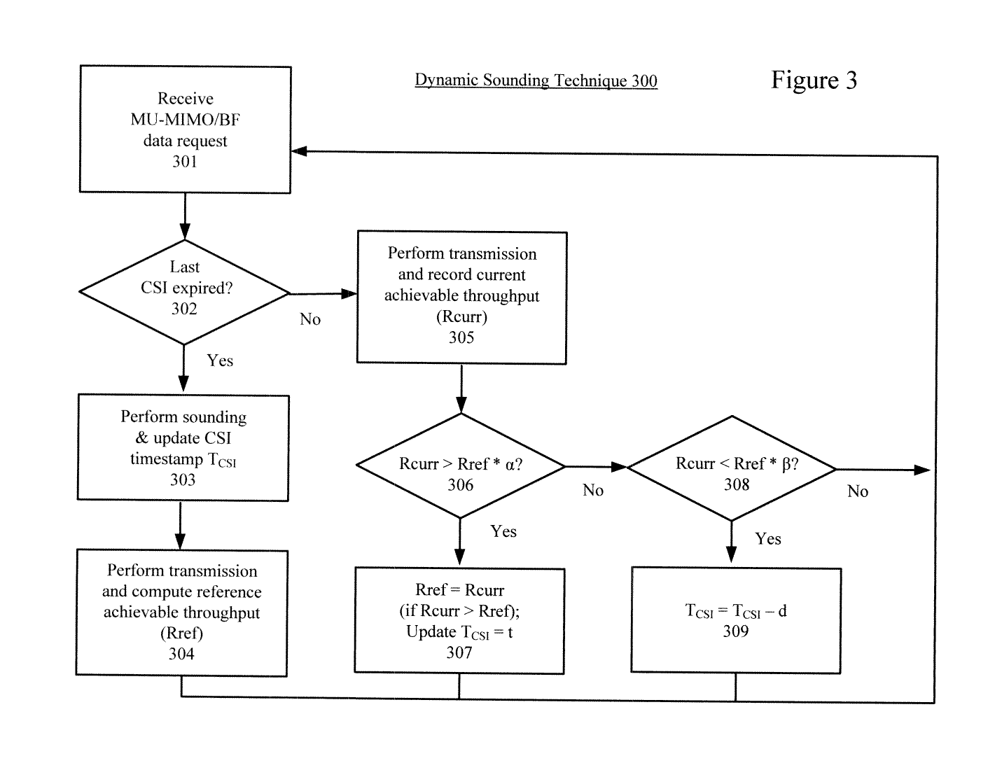

FIG. 3 illustrates an exemplary dynamic sounding technique 300, which can be implemented in a transmitter (or a transceiver). In step 301, a data request is received. Note that, in general, a scheduling block in the media access control MAC layer of the transmitter can decide the destinations of the signal, how to group the destinations for purposes of transmission, and how the data to those destinations should be transmitted (e.g. MU-MIMO, SU-MIMO, or beamforming).

Step 302 determines whether the CSI has expired. In one embodiment, this expiration can be determined by using a current timestamp t and a CSI timestamp T_{CSI}, which could be generated when a last sounding was performed. For example, when the difference of the current timestamp t and the CSI timestamp T_{CSI} is greater than a predetermined default CSI lifespan expiration time D,

t−T_{CSI}>D

then the CSI is said to have expired.

In one embodiment, the predetermined default CSI lifespan expiration time D can be derived from the transmit mode used and a Doppler profile. For example, time D in a beamforming transmit mode could have a long expiration time, e.g. on the order of 100-800 msec. In contrast, time D in a MU-MIMO transmit mode could have a much shorter expiration, e.g. on the order of 20-50 msec. Note that 3-user MU-MIMO may have a shorter expiration than 2-user MU-MIMO. When high Doppler is present, the expiration may need to be as fast as 5 msec to ensure optimized performance. In contrast, for static Doppler, the expiration could be 30-50 msec. Note that when a wireless device first transmits, the CSI is characterized as being expired in step 302.

When the CSI has expired, step 303 can perform a sounding and update the CSI timestamp T_{CSI} to be equal to the current timestamp, i.e. T_{CSI}=t. Step 304 can perform the transmission based on the updated CSI and then compute a reference achievable throughput Rref based on that transmission. In one embodiment,

Rref=Phyrate*(1-PER)

wherein Phyrate is the actual rate used in the transmission and PER is the packet error rate. Notably, as described below, this reference achievable throughput Rref, which is associated with the sounding (i.e. a throughput of the first transmission after sounding is performed), can be advantageously used to dynamically change the sounding interval.

When the last CSI is not expired (step 302), step 305 can perform the transmission using the unexpired CSI and record a current achievable throughput Rcurr. In one embodiment,

Rcurr=Phyrate (1-PER)

In other embodiments, both the current achievable throughput Rcurr and the reference achievable throughput Rref can use the MAC throughput instead of the actual rate Phyrate in the above equations.

Step 306 can determine whether the current achievable throughput Rcurr is greater than the product of the reference achievable throughput Rref and a, wherein a is a first predetermined control factor (explained in further detail below). If so, in step 307, the CSI timestamp T_{CSI} can be updated to be equal to the current timestamp, i.e. T_{CSI}=t, thereby effectively prolonging the lifespan of the current CSI. Additionally, when the current achievable throughput Rcurr is greater than the reference achievable throughput Rref, then step 307 can also update the reference achievable throughput Rref to be equal to the current achievable throughput Rcurr.

When the current achievable throughput Rcurr is not greater than the product of the reference achievable throughput Rref and a (step 306), step 308 can determine whether the current achievable throughput Rcurr is less than the product of the reference achievable throughput Rref and β, wherein β is a second predetermined control factor. In one embodiment, the first and second predetermined control factors can be set as follows: 0<β<αa<=1. Using these settings, the first and second predetermined control factors can help decide when to postpone and when to move forward with the next sounding while minimizing unnecessary configuration changes (i.e. changing the sounding interval too frequently would be inefficient and waste system resources). Step 309 can update the CSI timestamp T_{CSI} to be equal to the current timestamp T_{CSI} minus a predetermined delay d, i.e. T_{CSI}=T_{CSI}−d, thereby effectively shortening the lifespan of the current CSI and expediting the next sounding. In one embodiment, delay d can be large enough so that the current timestamp T_{CSI} expires immediately. When that happens, the next MU-MIMO transmission will trigger a new sounding. In general, delay d is another control factor to decide how much the next sounding should be moved forward. After any one of steps 304, 307, and 309, technique 300 returns to step 301 of receiving a new data request.

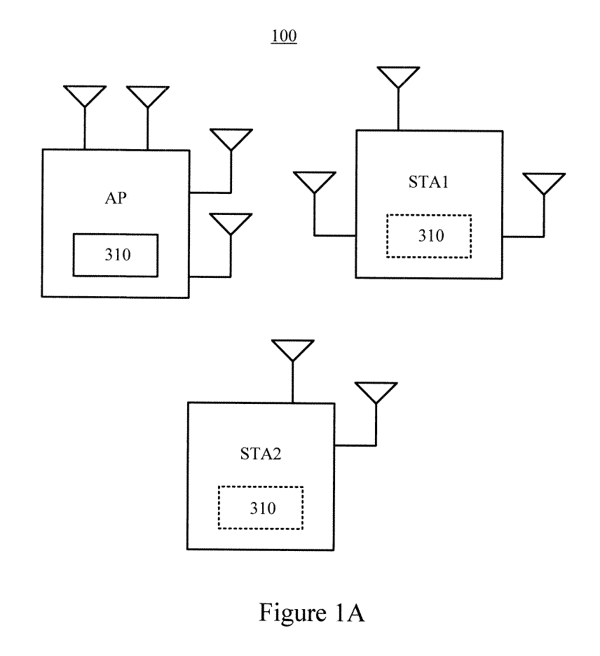

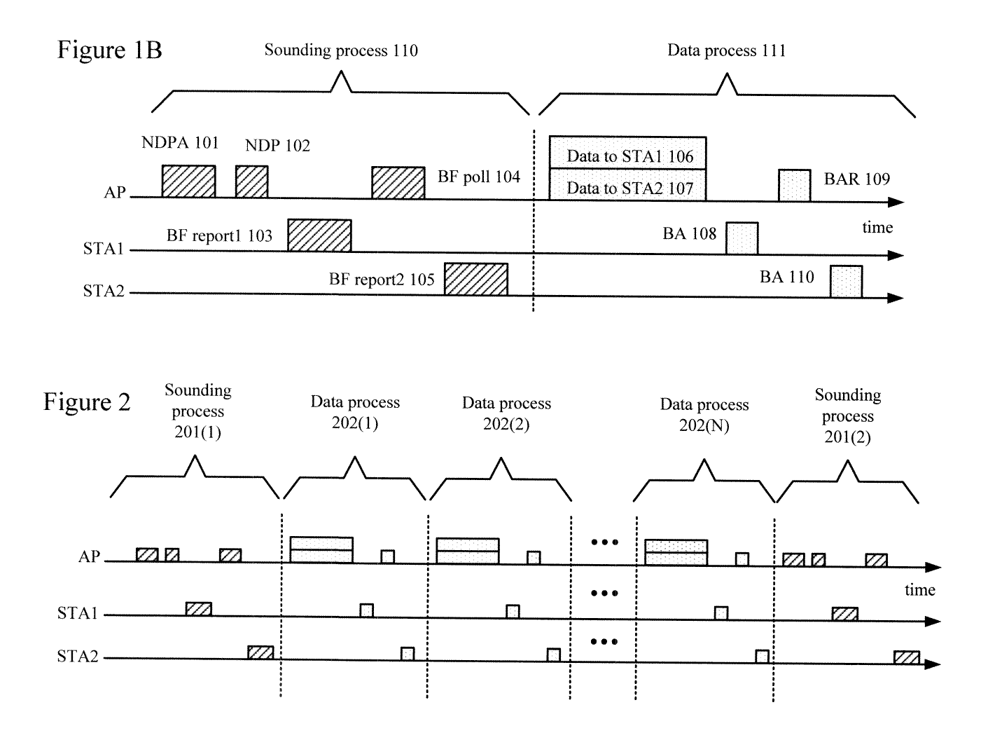

In one embodiment, the dynamic sounding technique 300 can be implemented in an AP (see, e.g. the AP of FIG. 1A). In another embodiment, the dynamic sounding technique 300 can be implemented in the AP as well as in at least one station (see, e.g. transceivers 310 of the AP, STA1 and/or STA2 in FIG. 1A).

Certain aspects of the dynamic sounding technique 300 described in FIG. 3 may take the form of an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not. A machine-readable medium includes any mechanism for storing (“machine-readable storage medium”) or transmitting (“machine-readable signal medium”) information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions (e.g., executable by one or more processing units). In addition, machine-readable signal medium embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

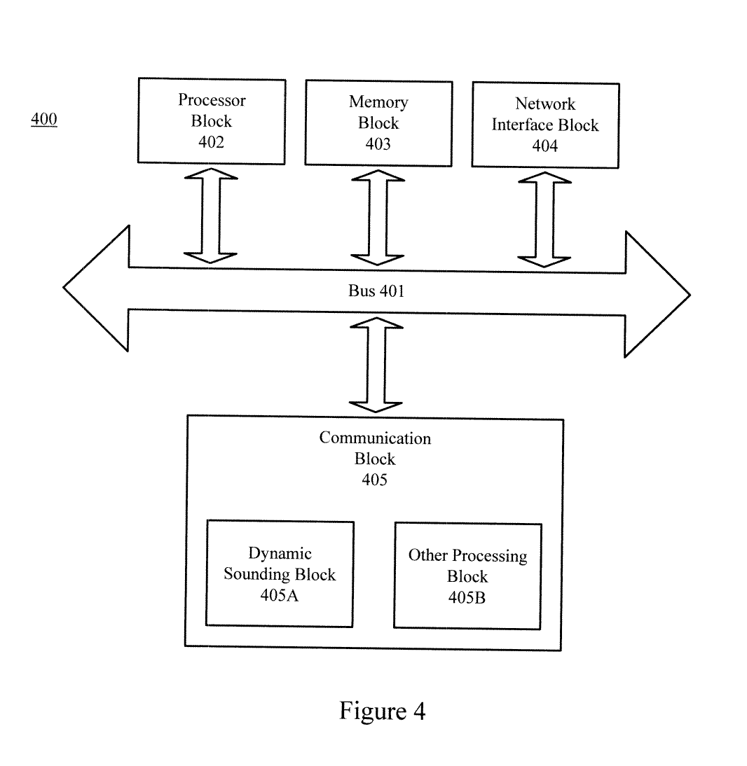

Although the dynamic sounding technique 300 is described as being performed by a transmitter, an electronic device having wireless capability typically includes certain components that may or may not be characterized as part of a transmitter. Indeed, in some embodiments, certain components of the electronic device may be characterized as outside the transceiver, but still assist in one or more steps of dynamic sounding technique 300. FIG. 4 illustrates a simplified electronic device 400 including a dynamic sounding block 405A, which can substantially perform the dynamic sounding technique 300. The electronic device 400 may be a notebook computer, a desktop computer, a tablet computer, a netbook, a mobile phone, a gaming console, a personal digital assistant (PDA), or other electronic system having wireless (and wired, in some cases) communication capabilities.

The electronic device 400 can include a processor block 402 (possibly including multiple processors, multiple cores, multiple nodes, and/or implementing multi-threading, etc.). The electronic device 400 can also include a memory block 403, which may include cache, SRAM, DRAM, zero capacitor RAM, Twin Transistor RAM, eDRAM, EDO RAM, DDR RAM, EEPROM, NRAM, RRAM, SONOS, PRAM, and/or another type of memory cell array. The electronic device 400 also includes a network interface block 404, which may include at least a WLAN 802.11 interface. Other network interfaces may include a Bluetooth interface, a WIMAX interface, a ZigBee® interface, a Wireless USB interface, and/or a wired network interface (such as an Ethernet interface, or a powerline communication interface, etc.). The processor block 402, the memory block 403, and the network interface block 404 are coupled to a bus 401, which may be implemented in accordance with PCI, ISA, PCI-Express, HyperTransport®, InfiniBand®, NuBus, AHB, AXI, or another bus standard.

The electronic device 400 also includes a communication block 405, which can include the above-described dynamic sounding block 405A and another processing block 405B. The other processing block 405B may include, but is not limited to, portions of a transceiver for processing received signals, for processing to be transmitted signals, and for coordinating actions of the receiver and transmitter portions. Other embodiments may include fewer or additional components not illustrated in FIG. 4, such as video cards, audio cards, additional network interfaces, and/or peripheral devices. In one embodiment, the memory block 403 may be connected directly to the processor block 402 to increase system processing.

The various embodiments of the structures and methods of described above are illustrative only and are not intended to limit the scope of the dynamic sounding technique and system embodiments described. For example, in one embodiment, steps 306 and 308 can be performed in parallel because only one of steps 306 and 308 can be true. Note that the dynamic sounding technique described herein can be easily incorporated into 802.11-compliant systems, and is fully consistent with the communication shown in FIG. 1B between various wireless devices.

1. A method of performing dynamic sounding in an electronic device, the electronic device including wireless communication capability, the method comprising:
receiving a data request using the electronic device;
determining whether a channel state information (CSI) has expired by comparing a current timestamp to a CSI timestamp, which indicates a time of a last CSI update;
when the CSI has expired, performing a sounding and updating the CSI timestamp;
after the sounding, performing a data transmission in accordance with the data request and computing a reference achievable throughput, which is associated with the sounding; and
when the CSI has not expired, performing the data transmission in accordance with the data request and recording a current achievable throughput.

2. The method of claim 1, wherein the data request is one of multi-user multiple-input multiple-output (MU-MIMO) and single-user beamforming (SU-BF).

3. The method of claim 1, further including:
using the current achievable throughput and the reference achievable throughput to determine whether a sounding interval is extended or shortened.

4. The method of claim 3, wherein comparing the current timestamp to the CSI timestamp includes:
determining whether the CSI timestamp subtracted from the current timestamp is greater than a predetermined default CSI lifespan expiration time.

5. The method of claim 4, wherein the predetermined default CSI lifespan expiration time is derived from a transmit mode and a Doppler profile.

6. The method of claim 3, wherein computing the reference achievable throughput includes computing a product of a physical rate of the data transmission performed immediately after sounding and a value indicative of transmission quality.

7. The method of claim 3, wherein computing the reference achievable throughput includes computing a product of a physical rate of the data transmission performed immediately after sounding and a value equal to 1 minus a packet error rate.

8. The method of claim 3, wherein using the current achievable throughput and the reference achievable throughput to determine whether the sounding interval is extended or shortened includes:
after recording the current achievable throughput, determining whether the current achievable throughput is greater than a product of the reference achievable throughput and a predetermined factor.

9. The method of claim 8, further including:
when the current achievable throughput is greater than the product of the reference achievable throughput and the predetermined factor, updating the CSI timestamp to equal the current timestamp, thereby extending the sounding interval.

10. The method of claim 9, further including when the current achievable throughput is greater than the reference achievable throughput, designating the current achievable throughput as the reference achievable throughput.

11. The method of claim 10, further including setting the predetermined factor to a value between 0 and 1.

12. The method of claim 3, wherein using the current achievable throughput and the reference achievable throughput to determine whether the sounding interval is extended or shortened includes:
after recording the current achievable throughput, determining whether the current achievable throughput is less than a product of the reference achievable throughput and a predetermined factor.

13. The method of claim 12, further including:
when the current achievable throughput is less than the product of the reference achievable throughput and the predetermined factor, reducing the CSI timestamp by a predetermined delay.

14. The method of claim 13, further including setting the predetermined factor to a value between 0 and 1.

15. A method of performing dynamic sounding in a wireless communication device, the method comprising:
determining whether to perform sounding based on an age of current channel state information (CSI);
updating an achievable throughput as a reference throughput after performing the sounding;
comparing a current achievable throughput with the reference throughput;
resetting a CSI timestamp when the current achievable throughput is above the reference throughput by a first predetermined amount, thereby prolonging a lifespan of the current CSI.

16. The method of claim 15, further including:
reducing the CSI timestamp when the current achievable throughput is below the reference throughput by a second predetermined amount, thereby reducing the lifespan of the current CSI.

17. An electronic device comprising:
a processor block; and
a communication block, the communication block including:
a dynamic sounding block configured to perform:
receiving a data request;
determining whether a channel state information (CSI) has expired by comparing a current timestamp to a CSI timestamp, which indicates a time of a last CSI update;
when the CSI has expired, performing a sounding and updating the CSI timestamp;
after the sounding, performing a data transmission in accordance with the data request and computing a reference achievable throughput, which is associated with the sounding;
when the CSI has not expired, performing the data transmission in accordance with the data request and recording a current achievable throughput.

18. The electronic device of claim 17, wherein the data request is one of multi-user multiple-input multiple-output (MU-MIMO) and single-user beamforming (SU-BF).

19. The electronic device of claim 17, further including:
using the current achievable throughput and the reference achievable throughput to determine whether a sounding interval is extended or shortened.

20. The electronic device of claim 19, wherein the comparing the current timestamp to the CSI timestamp includes:
determining whether the CSI timestamp subtracted from the current timestamp is greater than a predetermined default CSI lifespan expiration time.

21. The electronic device of claim 20, wherein the predetermined default CSI lifespan expiration time is derived from a transmit mode and a Doppler profile.

22. The electronic device of claim 19, wherein computing the reference achievable throughput includes computing a product of a physical rate of the data transmission performed immediately after sounding and a value indicative of transmission quality.

23. The electronic device of claim 19, wherein computing the reference achievable throughput includes computing a product of a physical rate of the data transmission performed immediately after sounding and a value equal to 1 minus a packet error rate.

24. The electronic device of claim 23, wherein using the current achievable throughput and the reference achievable throughput to determine whether the sounding interval is extended or shortened includes:
after recording the current achievable throughput, determining whether the current achievable throughput is greater than a product of the reference achievable throughput and a predetermined factor.

25. The electronic device of claim 24, wherein the dynamic sounding block is further configured to perform:
when the current achievable throughput is greater than the product of the reference achievable throughput and the predetermined factor, updating the CSI timestamp to equal the current timestamp, thereby extending the sounding interval.

26. The electronic device of claim 25, further including:
when the current achievable throughput is greater than the reference achievable throughput, designating the current achievable throughput as the reference achievable throughput.

27. The electronic device of claim 19, wherein using the current achievable throughput and the reference achievable throughput to determine whether the sounding interval is extended or shortened includes:
after recording the current achievable throughput, determining whether the current achievable throughput is less than a product of the reference achievable throughput and a predetermined factor.

28. The electronic device of claim 27, wherein the dynamic sounding block is further configured to perform:
when the current achievable throughput is less than the product of the reference achievable throughput and the predetermined factor, reducing the CSI timestamp by a predetermined delay.

29. A non-transitory, computer-readable medium storing computer-executable instructions for performing dynamic sounding for a transmitter of a wireless device, the instructions when executed by a processor cause the processor to execute a process comprising:
receiving a data request;
determining whether a channel state information (CSI) has expired by comparing a current timestamp to a CSI timestamp, which indicates a time of a last CSI update;
when the CSI has expired, performing a sounding and updating the CSI timestamp;
after the sounding, performing a data transmission in accordance with the data request and computing a reference achievable throughput, which is associated with the sounding; and
when the CSI has not expired, performing the data transmission in accordance with the data request and recording a current achievable throughput.

30. The computer-readable medium of claim 29, wherein the data request is one of multi-user multiple-input multiple-output (MU-MIMO) and single user beamforming (SU-BF).

31. The computer-readable medium of claim 29, further including:
using the current achievable throughput and the reference achievable throughput to determine whether a sounding interval is extended or shortened.

32. The computer-readable medium of claim 31, wherein the comparing the current timestamp to the CSI timestamp includes:
determining whether the CSI timestamp subtracted from the current timestamp is greater than a predetermined default CSI lifespan expiration time.

33. The computer-readable medium of claim 32, wherein the predetermined default CSI lifespan expiration time is derived from a transmit mode and a Doppler profile.

34. The computer-readable medium of claim 31, wherein computing the reference achievable throughput includes computing a product of a physical rate of the data transmission performed immediately after sounding and a value indicative of transmission quality.

35. The computer-readable medium of claim 31, wherein computing the reference achievable throughput includes computing a product of a physical rate of the data transmission performed immediately after sounding and a value equal to 1 minus a packet error rate.

36. The computer-readable medium of claim 31, wherein using the current achievable throughput and the reference achievable throughput to determine whether the sounding interval is extended or shortened includes:
after recording the current achievable throughput, determining whether the current achievable throughput is greater than a product of the reference achievable throughput and a predetermined factor.

37. The computer-readable medium of claim 36, further including:
when the current achievable throughput is greater than the product of the reference achievable throughput and the predetermined factor, updating the CSI timestamp to equal the current timestamp, thereby extending the sounding interval.

38. The computer-readable medium of claim 37, further including:
when the current achievable throughput is greater than the reference achievable throughput, designating the current achievable throughput as the reference achievable throughput.

39. The computer-readable medium of claim 31, wherein using the current achievable throughput and the reference achievable throughput to determine whether the sounding interval is extended or shortened includes:
after recording the current achievable throughput, determining whether the current achievable throughput is less than a product of the reference achievable throughput and a predetermined factor.

40. The computer-readable medium of claim 39, further including:
when the current achievable throughput is less than the product of the reference achievable throughput and the predetermined factor, reducing the CSI timestamp by a predetermined delay.
